(19) United States
(12) Patent Application Publication
(10) Pub. No.: US 2026/0176430 A1
(43) Pub. Date: Jun. 25, 2026

(54) METHOD FOR FABRICATION WORK FUNCTION-TUNABLE IONIC LIQUID-FUNCTIONALIZED POLY-3,4-ETHYLENEDIOXYTHIOPHENE:POLY-STYRENESULFONATE FILM

(71) Applicant: NATIONAL TAIWAN UNIVERSITY OF SCIENCE AND TECHNOLOGY, Taipei City (TW)

(72) Inventors: Chih-Yu CHANG, Taipei City (TW); Li-Fu HO, Taipei City (TW)

(73) Assignee: NATIONAL TAIWAN UNIVERSITY OF SCIENCE AND TECHNOLOGY, Taipei City (TW)

(21) Appl. No.: 19/261,561

(22) Filed: Jul. 7, 2025

(30) Foreign Application Priority Data
Dec. 24, 2024 (TW) 113150372

(51) Int. Cl. C08J 5/18

(52) U.S. Cl. CPC C08J 5/18; C08J 2341/00; C08J 2441/00

(57) ABSTRACT

A method for manufacturing a work function-tunable ionic liquid-functionalized poly-3,4-ethylenedioxythiophene:poly-styrenesulfonate (PEDOT:PSS) film. The method comprises: a pretreatment step, a film formation step, a film treatment step, and an ionic liquid treatment step. In the pretreatment step, a pretreatment solution is prepared by mixing PEDOT:PSS solution with methanol. In the film formation step, the pretreatment solution is blade-coated onto a substrate and subsequently annealing to form a first-stage film. In the film treatment step, dimethyl sulfoxide(DMSO) is blade-coated onto the first-stage film, followed by annealing. The DMSO-treated first-stage film washed with methanol to remove residual DMSO, forming a second-stage film. In the ionic liquid treatment step, an ionic liquid is ultrasonically agitated in deionized water to prepare an ionic liquid solution. This solution is blade-coated onto the second-stage film. The film is annealed washed with deionized water to remove the ionic liquid, thereby obtaining the ionic liquid-functionalized PEDOT:PSS film.

### FIELD OF THE INVENTION

The present invention relates to a method for fabricating poly-3,4-ethylenedioxythiophene:poly-styrenesulfonate (PEDOT:PSS) film, and more particularly to a method for fabricating an ionic liquid-functionalized PEDOT:PSS film with a tunable work function.

### BACKGROUND OF THE INVENTION

Poly-3,4-ethylenedioxythiophene (PEDOT) is a conductive polymer that, owing to its mechanical properties derived from its polymer structure and its electrical conductivity resulting from the conjugated structure, is considered a promising alternative to replace conventional metal oxides.

PEDOT is typically processed by adding poly-styrenesulfonate (PSS) as a counter anion to stabilize PEDOT chains, resulting in a stable aqueous dispersion of PEDOT:PSS suitable for solution-based processing.

However, when the hydrophobic PEDOT is surrounded by the hydrophilic PSS, a core-shell structure is formed. This results in a PSS-rich surface layer on the formed film, accounting for approximately 10% of the total film thickness, which leads to a reduction in the film's electrical conductivity.

Various methods for removing PSS from the surface of PEDOT chains have been developed in the past, including treatments with organic solvents, acids, and ionic liquids.

Previous studies have shown that adding polar organic solvents, such as dimethyl sulfoxide (DMSO), N,N-dimethylformamide (DMF), and tetrahydrofuran (THF) to PEDOT:PSS solutions can enhance conductivity. Moreover, depending on the type of the polar solvent added, the cohesion within the PEDOT:PSS system may also be affected.

Further studies have shown that post-treatment of PEDOT:PSS with DMSO or ethylene glycol (EG) can significantly enhance its conductivity. In contrast, treatments with common organic solvents such as ethanol, isopropanol (IPA), acetonitrile (ACN), and tetrahydrofuran (THF) do not result in a noticeable improvement in conductivity. However, when these organic solvents are used in combination with water to treat PEDOT:PSS films, a significant increase in conductivity is observed. The enhancement is believed to result from the weakening of the electrostatic attraction between the PEDOT and PSS chains, leading to the separation of the PSS shell. Such a change induces a conformational rearrangement of the PEDOT chains.

Previous studies have also shown that immersing PEDOT:PSS films in strong acids can enhance their electrical conductivity. When PEDOT:PSS films are treated with strong acids capable of self-proton dissociation, the acids dissociate into positively and negatively charged ions. These ions can stabilize the separated state of the positively charged PEDOT and negatively charged PSS chains, thereby weakening the electrostatic interactions between them and inducing phase separation. This structural rearrangement of the PEDOT chains significantly improves the conductivity of PEDOT:PSS. However, the use of strong acids poses health and environmental hazards, thereby limiting their suitability for commercial applications.

In recent years, studies have also explored the use of ionic liquids for the treatment of PEDOT:PSS. Through ion-exchange mechanisms, the PEDOT and PSS chains can be separated. Because ionic liquids exhibit characteristics of both organic and inorganic salts, such as excellent chemical stability, low flammability, low vapor pressure, and low volatility, making them suitable for processing applications.

However, when ionic liquids are mixed with PEDOT:PSS, gelation occurs, leading to particle formation or solution aggregation during the coating process. These effects present significant challenges for film formation and subsequent processing.

### SUMMARY OF THE INVENTION

Therefore, one objective of the present invention is to provide a method for fabricating a work function-tunable ionic liquid-functionalized PEDOT:PSS film, which can prevent the gelation phenomenon typically occurs when PEDOT:PSS is treated with ionic liquids, thereby enabling the fabrication of ionic liquid-functionalized PEDOT:PSS films that exhibit both high conductivity and tunable work function.

In order to overcome the technical problems of prior art, the present invention provides a method for fabricating a work function-tunable ionic liquid-functionalized PEDOT:PSS film, comprising: a pretreatment step of mixing a PEDOT:PSS solution and methanol to obtain a pretreatment solution; a film formation step of blade-coating the pretreatment solution onto a substrate and annealing to obtain a first-stage film; a film treatment step of blade-coating DMSO onto the first-stage film to obtain a DMSO-treated first-stage film, annealing the DMSO-treated first-stage film, and washing with methanol to remove DMSO, thereby obtaining a second-stage film; and an ionic liquid treatment step of ultrasonically agitating an ionic liquid with deionized water to obtain an ionic liquid solution, blade-coating the ionic liquid solution onto the second-stage film to obtain an ionic-liquid-treated film, annealing the ionic-liquid-treated film and washing with deionized water to remove the ionic liquid, thereby obtaining the ionic liquid-functionalized PEDOT:PSS film.

In one embodiment of the present invention, the method comprises, wherein the pretreatment step, the pretreatment solution consists of 80 vol % of the PEDOT:PSS solution and 20 vol % of methanol.

In one embodiment of the present invention, the method is provided, wherein the annealing is performed at 110° C.

In one embodiment of the present invention, the method comprises, wherein the blade coating step is performed under the following conditions of a gap of 0.2 mm, a blade angle of 45°, and a blade speed of 5 cm/min.

In one embodiment of the present invention, the method comprises, wherein the film forming step, the substrate is a glass substrate or a polyethylene terephthalate substrate.

In one embodiment of the present invention, the method comprises, wherein in the film formation step, the annealing is performed for 5 minutes.

In one embodiment of the present invention, the method comprises, wherein in the film treatment step, the annealing is performed for 10 minutes.

In one embodiment of the present invention, the method comprises, wherein in the ionic liquid treatment step, the annealing is performed for 10 minutes.

Through the technical means adopted by the present invention, the gelation phenomenon typically occurring during the pretreatment of PEDOT:PSS with ionic liquids can be avoided, thereby yielding a PEDOT:PSS film surface-functionalized with ionic liquid. The resulting ionic liquid-functionalized PEDOT:PSS film exhibits excellent conductivity and possesses a tunable work function through the use of different ionic liquids.

### BRIEF DESCRIPTION OF THE DRAWINGS

FIG. 1 is a flowchart illustrating a method of fabricating an ionic liquid-functionalized PEDOT:PSS film according to one embodiment of the present invention;

FIG. 2a shows the untreated PEDOT:PSS solution;

FIG. 2b shows the PEDOT:PSS solution mixed with 1 wt % of ionic liquid;

FIG. 3 is a schematic diagram showing the preparation of a large-area ionic liquid-functionalized PEDOT:PSS film using a blade-coating method;

FIG. 4 is a schematic diagram showing the mechanism of ion exchange;

FIG. 5a is a Raman spectrum graph illustrating the full spectral range of the PEDOT:PSS film;

FIG. 5b is an enlarged view of the Raman shift region between 1350 and 1480 cm⁻¹ in FIG. 5a;

FIG. 5c is a schematic diagram illustrating the transformation of the PEDOT chains from the self-coiled benzoid structure into the quinoid structure;

FIG. 6 is a result graph showing the depth profile analysis of the untreated PEDOT:PSS film;

FIG. 7a shows the coating result of the untreated PEDOT:PSS solution;

FIG. 7b shows the coating result of the PEDOT:PSS solution with methanol added;

FIG. 8a is a schematic diagram illustrating the structure of a contact-separation-type TENG device;

FIG. 8b is a result graph showing the V_{OC} output measurement;

FIG. 8c is a result graph showing the I_{SC} output measurement; and

FIG. 8d is a result graph showing the Q_{SC} output measurement.

### DETAILED DESCRIPTION OF THE PREFERRED EMBODIMENTS

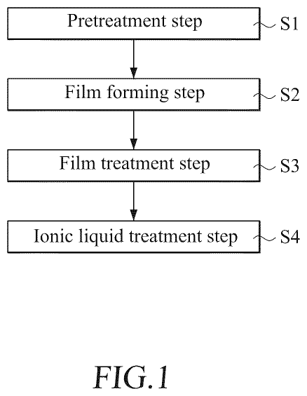

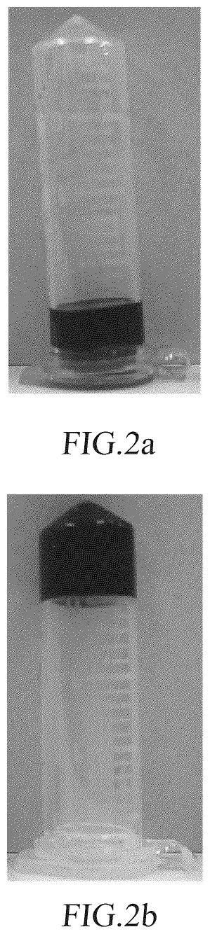

FIG. 1 to 8d illustrates the detailed embodiments of the present invention. The following description is used for explaining the embodiments of the present invention, rather than to limit the scope of the claims. FIG. 2 illustrates the deficiencies of the prior art and does not take part of the claimed invention.

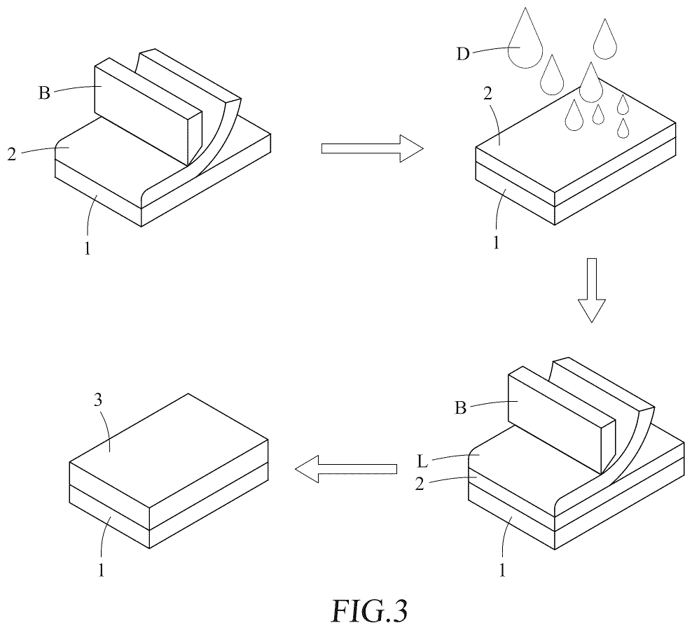

FIG. 1 and FIG. 3 show the embodiment of the present invention. In this embodiment, the fabrication of an ionic liquid-functionalized poly-3,4-ethylenedioxythiophene:poly-styrenesulfonate (PEDOT:PSS) film includes the following steps: a pretreatment step (S1), a film forming step (S2), a film treatment step (S3), and an ionic liquid treatment step (S4).

As shown in the pretreatment step (S1) of FIG. 1 and FIG. 3, methanol was added to PEDOT:PSS solution, and the resulting mixture was ultrasonically agitated to obtain pretreatment solution.

As shown in the film forming step (S2) of FIG. 1 and FIG. 3, the pretreatment solution was blade-coated onto a substrate (1) using a blade (B), and the substrate is annealed to obtain a first-stage film (2) (i.e., a PEDOT:PSS film).

In the film forming step (S2), methanol was added to the PEDOT:PSS solution to accelerate the drying of the film and weaken the interaction between PEDOT and PSS, thereby enhancing the subsequent ion exchange effect.

As shown in the film treatment step (S3) of FIG. 1 and FIG. 3, DMSO (D) was blade-coated onto the first-stage film (2) using a blade (B) to yield a DMSO (D)-treated first-stage film (2). The DMSO (D)-treated first-stage film (2) was then annealed and rinsed with methanol to remove the DMSO (D), thereby yielding a second-stage film.

In the film treatment step (S3), the PEDOT:PSS film was treated with DMSO (D). Due to the shielding effect of DMSO (D), the electrostatic interaction between PEDOT and PSS was weakened, thereby enhancing the ion exchange effect described later. The film was then rinsed with methanol to remove a portion of the PSS and DMSO (D).

As shown in the ionic liquid treatment step (S4) of FIG. 1 and FIG. 3, deionized water was added to the ionic liquid and ultrasonically agitated to yield an ionic liquid aqueous solution (L). The ionic liquid aqueous solution (L) was blade-coated onto the second-stage film using a blade (B) to yield an ionic liquid-treated film. The ionic liquid-treated film was annealed and then rinsed with deionized water to remove the ionic liquid, thereby yielding an ionic liquid-functionalized PEDOT:PSS film (3).

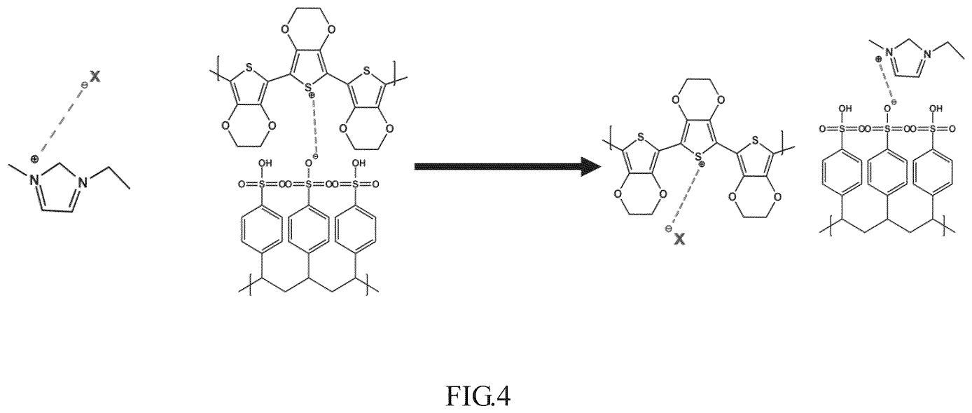

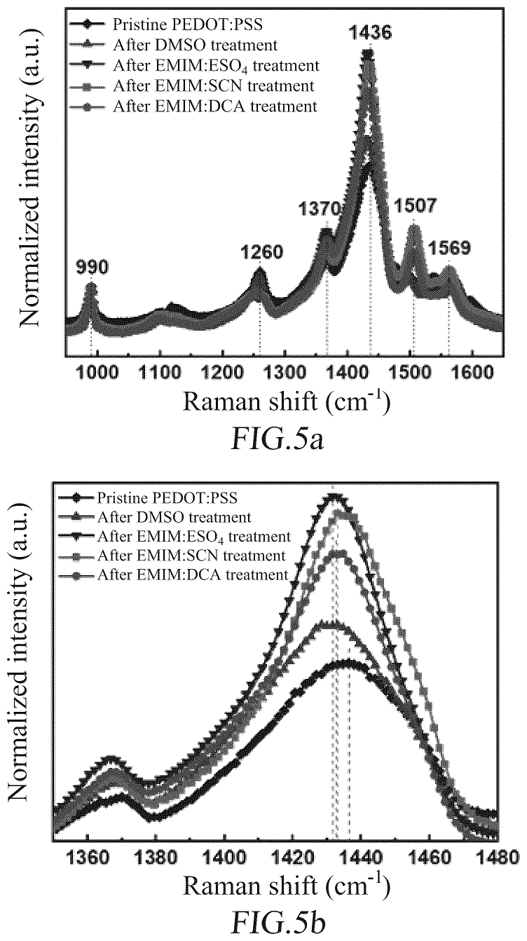

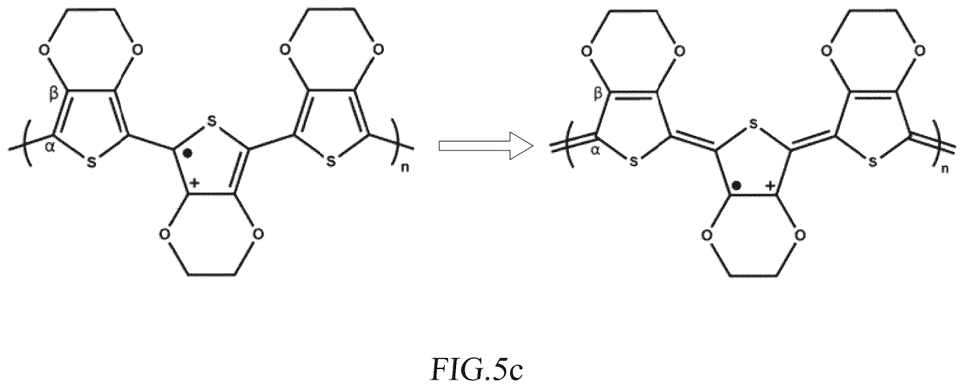

FIG. 4 is a schematic diagram showing the mechanism of ion exchange. In the ionic liquid treatment step (S4), the second-stage film was treated with an ionic liquid, allowing the anions and cations of the ionic liquid to replace PEDOT and PSS through ion exchange. As shown in the Raman spectra results of FIG. 5a, FIG. 5b, and FIG. 5c, the untreated PEDOT:PSS film, as well as the films treated with DMSO (D), 1-ethyl-3-methylimidazolium ethyl sulfate (EMIM:ESO₄), 1-ethyl-3-methylimidazolium dicyanamide (EMIM:DCA), and 1-ethyl-3-methylimidazolium thiocyanate (EMIM:SCN), were analyzed by Raman spectroscopy. The results show that, after the treatment with the ionic liquid, the peak intensities at 1436 cm⁻¹ and 1507 cm⁻¹ increased, and a red shift was observed at the 1436 cm⁻¹ peak. This transformation indicates that the conjugation length of the PEDOT chains increases, showing that the PEDOT chains transform from a coiled benzoid structure into a quinoid structure, thereby enhancing charge transport capability. Furthermore, the surface ionic liquid and PSS can be rinsed off with deionized water resulting in the ionic liquid-functionalized PEDOT:PSS film with good electrical conductivity.

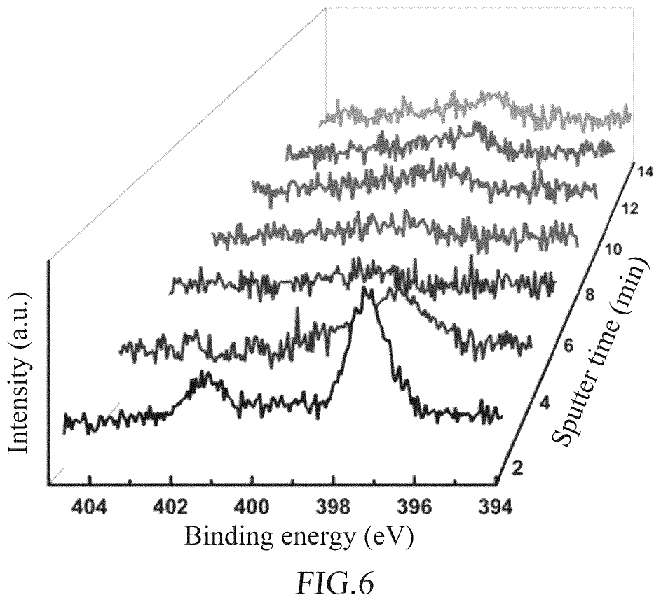

FIG. 6 is a result graph showing the depth profile analysis of the original untreated PEDOT:PSS film. The PEDOT:PSS film fabricated by blade-coating typically forms a PSS-rich surface layer approximately 12 nm thick. Therefore, the ionic liquid can effectively interact with PSS, making it possible to efficiently remove the PSS from the film by rinsing with deionized water.

According to the method for fabricating the ionic liquid-functionalized PEDOT:PSS film of an embodiment of the present invention, the pretreatment solution in the pretreatment step consists of 80 vol % of the PEDOT:PSS solution and 20 vol % of methanol.

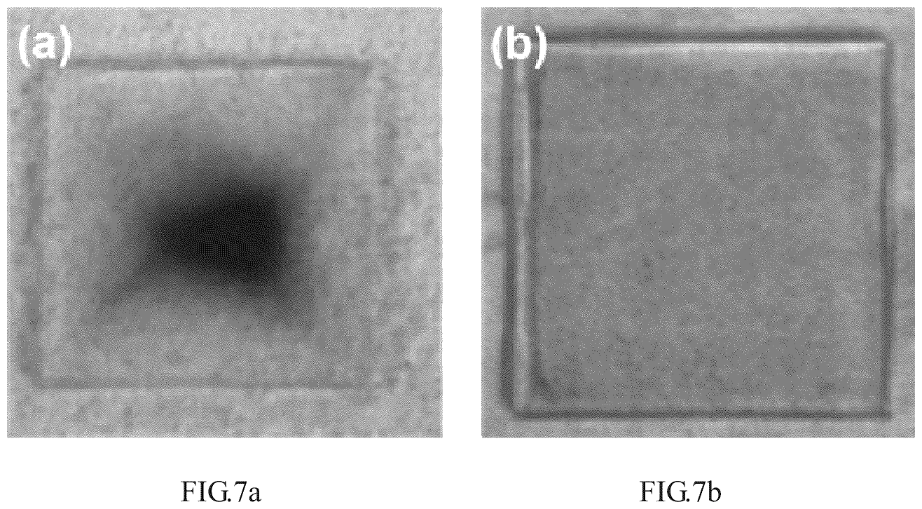

With this composition, an accelerated drying effect is ideal to improve the uniformity of PEDOT in the first-stage film, as shown in FIG. 7a and FIG. 7b.

According to the method for fabricating the ionic liquid-functionalized PEDOT:PSS film of an embodiment of the present invention, the annealing is performed at 110° C.

By means of such a temperature setting, an appropriate temperature can be provided to facilitate solvent drying without affecting the film formation process.

According to the method for fabricating the ionic liquid-functionalized PEDOT:PSS film of an embodiment of the present invention, the blade-coating was performed under the following conditions of a 0.2 mm gap, a blade angle of 45°, and a blade speed of 5 cm/min.

According to the above conditions, a high-quality film can be formed through the blade-coating.

According to the method for fabricating the ionic liquid-functionalized PEDOT:PSS film of an embodiment of the present invention, the substrate used in the film formation step is a glass substrate or a polyethylene terephthalate substrate.

According to the method for fabricating the ionic liquid-functionalized PEDOT:PSS film of an embodiment of the present invention, the annealing was performed for 5 minutes in the film forming step (S2).

According to the method for fabricating the ionic liquid-functionalized PEDOT:PSS film of an embodiment of the present invention, the annealing was performed for 10 minutes in the film treatment step (S3).

According to the method for fabricating the ionic liquid-functionalized PEDOT:PSS film of an embodiment of the present invention, the annealing was performed for 10 minutes in the ionic liquid treatment step (S4).

By setting the annealing duration in such a manner, an appropriate temperature can be provided to promote solvent evaporation without affecting the film forming process (S2).

In the ionic liquid treatment step (S4) of the embodiment of the present invention, examples of the ionic liquid include EMIM:ESO₄, EMIM:DCA, or EMIM:SCN.

By using ionic liquids such as EMIM:ESO₄, EMIM:DCA, or EMIM:SCN to treat the second-stage film, the work function of the film can be either increased or decreased depending on ionic liquids.

The work function of the film can be obtained by scanning with Kelvin probe force microscopy (KPFM). In the embodiment of the present invention, the scans were conducted on the untreated film and films treated with each of the three ionic liquids. The results show in Table 1.

TABLE 1

| Film | Work function obtained by KPFM (eV) |
|---|---|
| Untreated | 5.10 |
| Treated by EMIM:ESO₄ | 4.61 |
| Treated by EMIM:DCA | 4.82 |
| Treated by EMIM:SCN | 5.20 |

As shown in table 1, treatments with different ionic liquids can significantly alter the surface work function of the PEDOT:PSS film compared with the untreated PEDOT:PSS film. This variation may be attributed to the ion exchange interaction between the ionic liquid and PEDOT, due to the differences in the force between the anions and PEDOT, as well as variations in the dipole moment and electron-donating or electron-withdrawing abilities of the anions. This leads to changes in the charge dissipation capacity on the surface of PEDOT, thereby resulting in the differences in the work function.

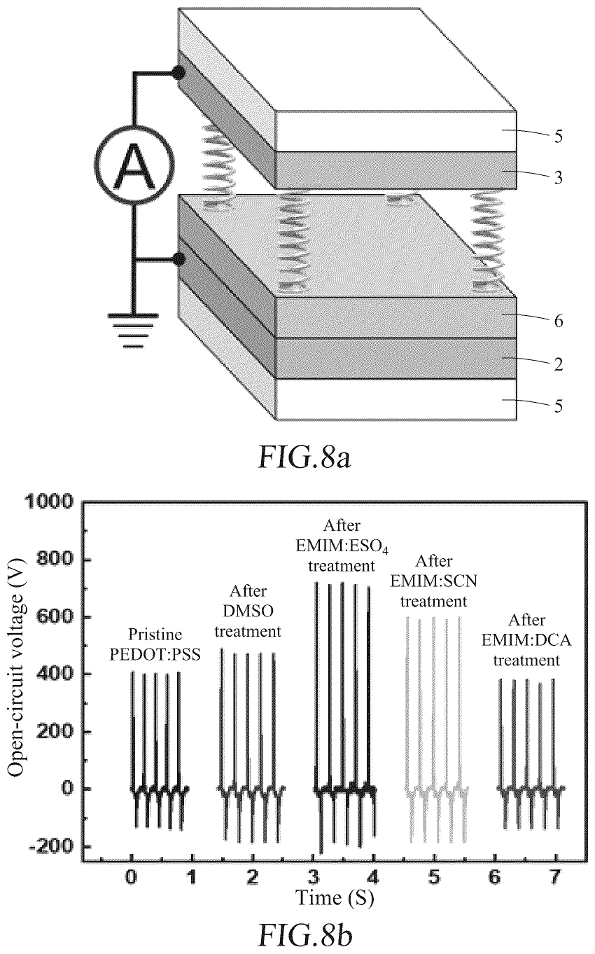

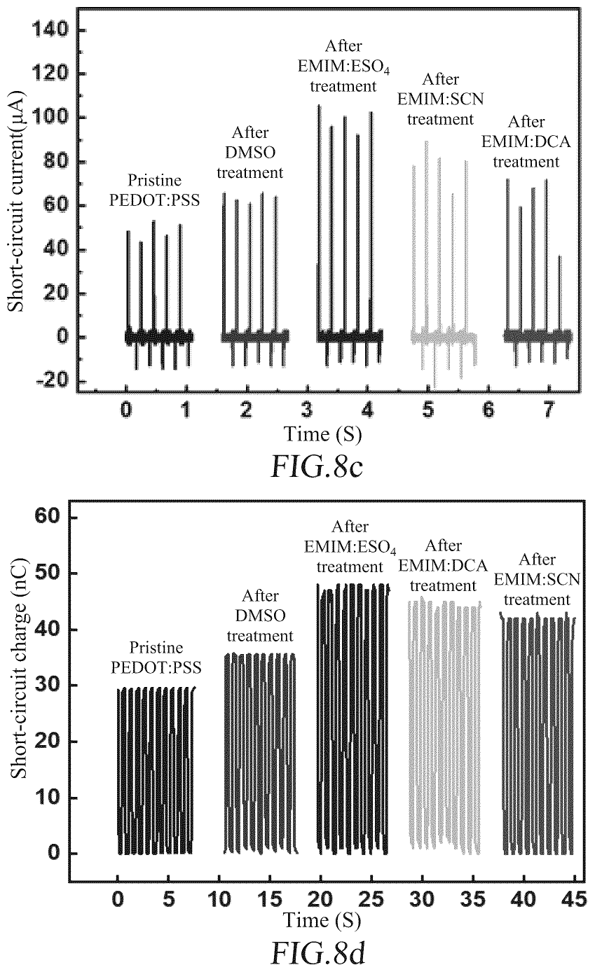

According to the technical means of the present invention, the gelation phenomenon that occurs during the process of PEDOT:PSS treated with an ionic liquid can be avoided, thereby yielding an ionic liquid-functionalized PEDOT:PSS film through surface functionalization with the ionic liquid. Due to its excellent mechanical stability and high conductivity, this film can serve as a large-area electrode for applications, such as triboelectric nanogenerators. Triboelectric nanogenerators can generate electrostatic polarization charges on the surface of electrodes through triboelectric or contact electrification. Furthermore, by employing different ionic liquids in the manufacturing method of the present invention, it is possible to tune the work function of the ionic liquid-functionalized PEDOT:PSS film. This allows for maximizing the work function difference between the electrode layer and the triboelectric dielectric layer, thereby enhancing the output performance of the triboelectric nanogenerator. FIG. 8a shows the triboelectric nanogenerator device includes a polyethylene naphthalate (PEN) film (5), a first-stage film (2) (i.e., PEDOT:PSS film) served as the anode, a polydimethylsiloxane (PDMS) film (6), and an ionic liquid-functionalized PEDOT:PSS film (3). FIGS. 8b, 8c, and 8d show the test results of the triboelectric nanogenerator.

The above descriptions should be considered as only the discussion of the preferred embodiments of the present invention. However, a person having common skill in the art may make various modifications without deviating from the present invention. Those modifications still fall within the scope of the present invention.

What is claimed is:

1. A method for manufacturing a work function-tunable ionic liquid-functionalized poly-3,4-ethylenedioxythiophene:poly-styrenesulfonate (PEDOT:PSS) film, comprising:
a pretreatment step of mixing a PEDOT:PSS solution and methanol to obtain a pretreatment solution;
a film formation step of blade-coating the pretreatment solution onto a substrate and annealing to obtain a first-stage film;
a film treatment step of blade-coating DMSO onto the first-stage film to obtain a DMSO-treated first-stage film, annealing the DMSO-treated first-stage film, and washing with methanol to remove DMSO, thereby obtaining a second-stage film; and an ionic liquid treatment step of ultrasonically agitating an ionic liquid with deionized water to obtain an ionic liquid solution, blade-coating the ionic liquid solution onto the second-stage film to obtain an ionic-liquid-treated film, annealing the ionic-liquid-treated film and washing with deionized water to remove the ionic liquid, thereby obtaining the ionic liquid-functionalized PEDOT:PSS film.

2. The method as claimed in claim 1, wherein in the pretreatment step, the pretreatment solution consists of 80 vol % of the PEDOT:PSS solution and 20 vol % of methanol.

3. The method as claimed in claim 1, wherein the annealing is performed at 110° C.

4. The method as claimed in claim 1, wherein the blade-coating is performed under the following conditions of a gap of 0.2 mm, a blade angle of 45°, and a blade speed of 5 cm/min.

5. The method as claimed in claim 1, wherein in the film formation step, the substrate is a glass substrate or a polyethylene terephthalate substrate.

6. The method as claimed in claim 1, wherein in the film formation step, the annealing is performed for 5 minutes.

7. The method as claimed in claim 1, wherein in the film treatment step, the annealing is performed for 10 minutes.

8. The method as claimed in claim 1, wherein in the ionic liquid treatment step, the annealing is performed for 10 minutes.
